(19) United States
(12) Patent Application Publication
(10) Pub. No.: US 2025/0021827 A1
(43) Pub. Date: Jan. 16, 2025

(54) METHOD FOR FINDING AT LEAST ONE OPTIMAL POST-TRAINING QUANTIZATION MODEL AND A NON-TRANSITORY MACHINE-READABLE MEDIUM

(71) Applicant: MEDIATEK INC., Hsin-Chu (TW)

(72) Inventor: Chia-Lin Yu, Hsinchu City (TW)

(73) Assignee: MEDIATEK INC., Hsin-Chu (TW)

(21) Appl. No.: 18/748,071

(22) Filed: Jun. 19, 2024

Related U.S. Application Data
(60) Provisional application No. 63/513,127, filed on Jul. 12, 2023.

(51) Int. Cl. G06N 3/0985; G06N 3/0495

(52) U.S. Cl. CPC G06N 3/0985; G06N 3/0495

(57) ABSTRACT

A method for finding at least one optimal post-training quantization model includes converting and optimizing a floating-point machine learning model into a converted machine learning model, applying a plurality of PTO settings to generate a plurality of PTO models, and evaluating the plurality of PTO models based on at least one predetermined indirect metric to find at least one optimal PTO model.

### CROSS REFERENCE TO RELATED APPLICATIONS

This application claims the benefit of U.S. Provisional Application No. 63/513,127, filed on Jul. 12, 2023. The content of the application is incorporated herein by reference.

### BACKGROUND

Quantization refers to the process of reducing the precision of numerical values in a neural network model, typically from 32-bit floating-point to lower-bit integer values, to reduce memory footprint and improve inference speed. Post-training quantization (PTQ) is a method for doing quantization after the neural network model is trained.

PTQ is a quantization technique that can reduce model size while improving CPU and hardware accelerator latency with little degradation in model accuracy. When performing PTQ, the PTQ options would affect both quantized model quality and the inference performance/power. The PTQ options can be classified into three independent categories:
1. Precision Setting: The bitwidth and symmetric/asymmetric setting for weight and activation tensors.
2. Quantization Error Minimization Algorithm: Extra algorithm to reduce the output differences between the quantized model and the floating-point model.
3. Calibration Scheme: The method for deducing quantization range from PTQ calibration dataset.

Since the best PTQ options (with the best quantized model quality) are different among models/datasets, users need to perform manual explorations to find the best PTQ options, which is time-consuming and requires significant efforts.

### SUMMARY

A method for finding at least one optimal post-training quantization model includes a converting and optimizing floating-point machine learning model into a converted machine learning model, applying a plurality of PTQ settings to generate a plurality of PTQ models, and evaluating the plurality of PTO models based on at least one predetermined indirect metric to find at least one optimal PTQ model.

A non-transitory machine-readable medium for storing a program code, wherein when loaded and executed by a processor, the program code instructs the processor to execute: converting and optimizing a floating-point machine learning model into a converted machine learning model, applying a plurality of PTQ settings to generate a plurality of PTQ models, and evaluating the plurality of PTQ models based on at least one predetermined indirect metric to find at least one optimal PTQ model.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of a quantization system for post-training quantization (PTQ) according to an embodiment of the present invention.

FIG. 2 is a flowchart of a method for finding at least one optimal post-training quantization (PTQ) model according to an embodiment of the present invention.

FIG. 3 is a flowchart of the method for finding at least one optimal post-training quantization (PTQ) model according to another embodiment of the present invention.

FIG. 4 is a block diagram of an exploration process according to an embodiment of the present invention.

### DETAILED DESCRIPTION

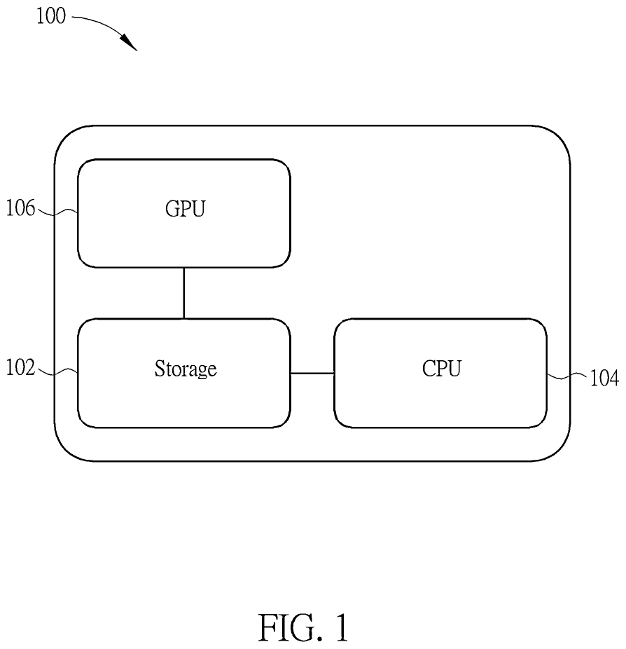

FIG. 1 shows a block diagram of a quantization system 100 for post-training quantization (PTQ) according to an embodiment of the present invention. The quantization system 100 includes a storage 102, a center processing unit (CPU) 104, and a graphic processing unit (GPU) 106. The CPU 104 and the GPU 106 are coupled to the storage 102 for accessing data. In this disclosure, storage 102 can store program code, when the program code loaded from the storage 102 to the CPU 104 or GPU 106, the CPU 104 or the GPU 106 executes the methods for finding at least one optimal post-training quantization (PTQ) model. In other embodiments, the quantization system 100 may comprises other processors or function units, and when the program code loaded from the storage 102 to the other processors or function units, the other processors or function units execute the methods for finding at least one optimal post-training quantization (PTQ) model. In an embodiment, the storage 102 is a non-transitory machine-readable medium.

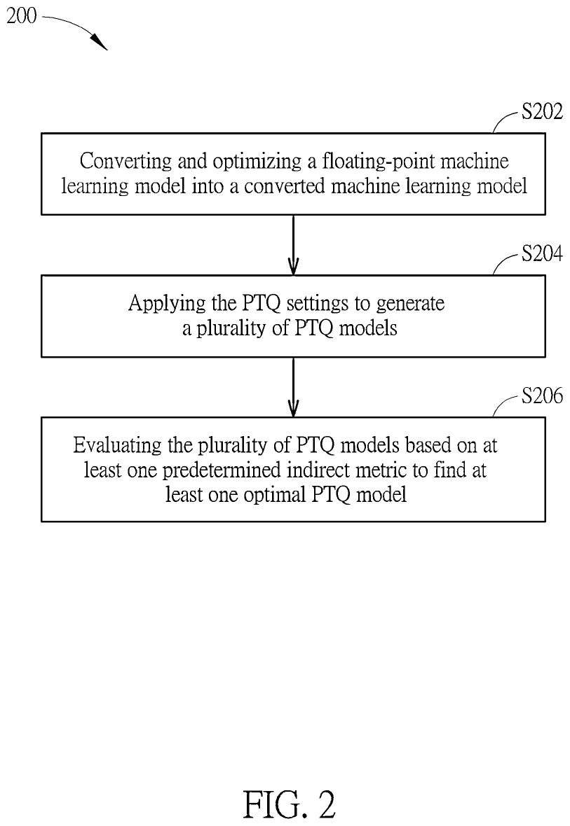

FIG. 2 is a flowchart of a method 200 for finding at least one optimal post-training quantization (PTQ) model according to an embodiment of the present invention. The method 200 may include the following steps:
Step S202: converting and optimizing a floating-point machine learning model into a converted machine learning model;
Step S204: applying the PTQ settings to generate a plurality of PTQ models; and
Step S206: evaluating the plurality of PTQ models based on at least one predetermined indirect metric to find at least one optimal PTQ model.

In an embodiment, in a preparation stage, configures three PTQ setting categories, that is, configures a plurality of precision settings (A1, A2, . . . ), quantization error minimization algorithms (B1, B2, . . . ), and calibration schemes (C1, C2, . . . ), performs Cartesian product on above three PTQ setting categories to form a plurality of PTQ settings, sorts the plurality of PTQ settings based on lexicographical order, and stores the sorted PTQ settings in the storage 102, each of the plurality of PTQ settings may include a precision setting, a quantization error minimization algorithm, and a calibration scheme. In an embodiment, the precision settings are the bitwidth and symmetric/asymmetric settings for weight and activation tensors, the quantization error minimization algorithms are extra algorithms to reduce the output differences between the quantized model and the floating-point model, and the calibration schemes are the methods for deducing quantization range from PTQ calibration dataset.

In step S202, the flowchart starts by loading the pre-trained floating-point machine learning model, and the floating-point machine learning model is converted and optimized into a converted machine learning model. In an embodiment, the floating-point machine learning model is converted from a neural network training framework (e.g., PyTorch, TensorFlow) to the target framework for model deployment (e.g., TFLite).

In step S204, the PTQ settings are loaded from the storage 102 one by one. In some embodiments, the PTQ settings are loaded from the storage 102 to the CPU 104 or the GPU 106. In other embodiments, the PTQ settings are loaded from the storage 102 to other processors or function units. In an embodiment, each of the plurality of PTQ settings may include a precision setting, a quantization error minimization algorithm, and a calibration scheme.

In an embodiment, in step S204, when applying the plurality of PTQ settings to generate a plurality of PTQ models, skipping at least one redundant operation if at least two PTQ settings have the same precision setting, quantization error minimization algorithm, or calibration scheme. In an example, at first, a first PTQ setting is applied to generate a first PTQ model, the first PTQ setting has a first precision setting, a first quantization error minimization algorithm, and a first calibration scheme, and then a second PTQ setting is applied to generate a second PTQ model, the second PTQ setting has a second precision setting, a second quantization error minimization algorithm, and a second calibration scheme, if the second precision setting is the same as the first precision setting, skips the redundant operation(s) relates to the second precision setting when generating the second PTQ model, if the second quantization error minimization algorithm is the same as the first quantization error minimization algorithm, skips the redundant operations relates to the second quantization error minimization algorithm when generating the second PTQ model, and if the second calibration scheme is the same as the first calibration scheme, skips the redundant operations relates to the second calibration scheme when generating the second PTQ model. In another example, at first, a first PTQ setting is applied to generate a first PTQ model, the first PTQ setting has a first precision setting, a first quantization error minimization algorithm, and a first calibration scheme, and then a second PTQ setting is applied to generate a second PTQ model, the second PTQ setting has a second precision setting, a second quantization error minimization algorithm, and a second calibration scheme, during generating the second PTQ model, check whether the second precision setting is the same as the first precision setting, skips the redundant operations relates to the second precision setting if the second precision setting is the same as the first precision setting, otherwise executes all the operations relates to the second precision setting, the second quantization error minimization algorithm, and the second calibration scheme; if the second precision setting is the same as the first precision setting, further check whether the second quantization error minimization algorithm is the same as the first quantization error minimization algorithm, skips the redundant operations relates to the second quantization error minimization algorithm if the second quantization error minimization algorithm is the same as the first quantization error minimization algorithm, otherwise executes all the operations relates to the second quantization error minimization algorithm, and the second calibration scheme; if the second quantization error minimization algorithm is the same as the first quantization error minimization algorithm, further check whether the second calibration scheme is the same as the first calibration scheme, skips the redundant operations relates to the second calibration scheme, otherwise executes the operations relates to the second calibration scheme. In another example, if a first PTQ and a second PTQ setting have the same precision setting, skipping at least one redundant operation comprises: skipping quantizing the constant weight tensors of the converted machine learning model based on the precision setting of the second PTQ setting. In another example, if a first PTQ and a second PTQ setting have the same precision setting and the same quantization error minimization algorithm, skipping at least one redundant operation comprises: skipping quantizing the constant weight tensors of the converted machine learning model based on the precision setting of the second PTQ setting; skipping running the quantization error minimization algorithm of the second PTQ setting to compensate weight quantization error; and skipping collecting tensor statistics from PTQ calibration dataset. In another example, if a first PTQ and a second PTQ setting have the same precision setting, the same quantization error minimization algorithm, and the same calibration scheme, skipping at least one redundant operation comprises: skipping quantizing the constant weight tensors of the converted machine learning model based on the precision setting of the second PTQ setting; skipping running the quantization error minimization algorithm of the second PTQ setting to compensate weight quantization error; skipping collecting tensor statistics from PTQ calibration dataset; and skipping running the calibration scheme of the second PTQ setting based on the collected tensor statistics to calibrate the activation tensors of the converted machine learning model.

In an embodiment, in step S206, the at least one indirect metric may be signal-to-quantization-noise ratio (SQNR), mean absolute error (MAE), mean squared error (MSE), or cosine similarity. In an embodiment, in step S206, executing at least one of the following operations to obtain a plurality of evaluation results: calculating SQNR difference between the floating-point machine learning model and each of the plurality of PTQ models; calculating the MAE between the floating-point machine learning model and each of the plurality of PTQ models; calculating the MSE between the floating-point machine learning model and each of the plurality of PTQ models; calculating cosine similarity between the floating-point machine learning model and each of the plurality of PTQ models. After obtaining the plurality of evaluation results, comparing all the evaluation results to find at least one optimal PTQ model. In an embodiment, in step S206, only find one optimal PTQ model, the optimal PTQ model is the best PTQ model. In another embodiment, in step S206, find more than one optimal PTQ models, the optimal PTQ models are the best PTQ model, the second best PTQ model, and so on. In an embodiment, the at least one optimal PTQ model is any one or a combination of: a PTQ model has the closest SQNR to the floating-point machine learning model, a PTQ model which can obtain the smallest MAE, a PTQ model which can obtain the smallest MSE, a PTQ model which can obtain the optimal cosine similarity. That is, an optimal PTQ model may be a PTQ model has the closest SQNR to the original floating-point machine learning model, or an optimal PTQ model may be a PTQ model which can obtain the smallest MAE compared with the original floating-point machine learning model, or an optimal PTQ model may be a PTQ model which can obtain the smallest MSE compared with the original floating-point machine learning model, or an optimal PTQ model may be a PTQ model which can obtain the optimal cosine similarity when compared with the original floating-point machine learning model, or an optimal PTQ model may be a PTQ model has at least one advantage of the above mentioned advantages.

In some embodiments, steps S204 and S206 are executed by the CPU 104, the GPU 106, other processors, or other function units.

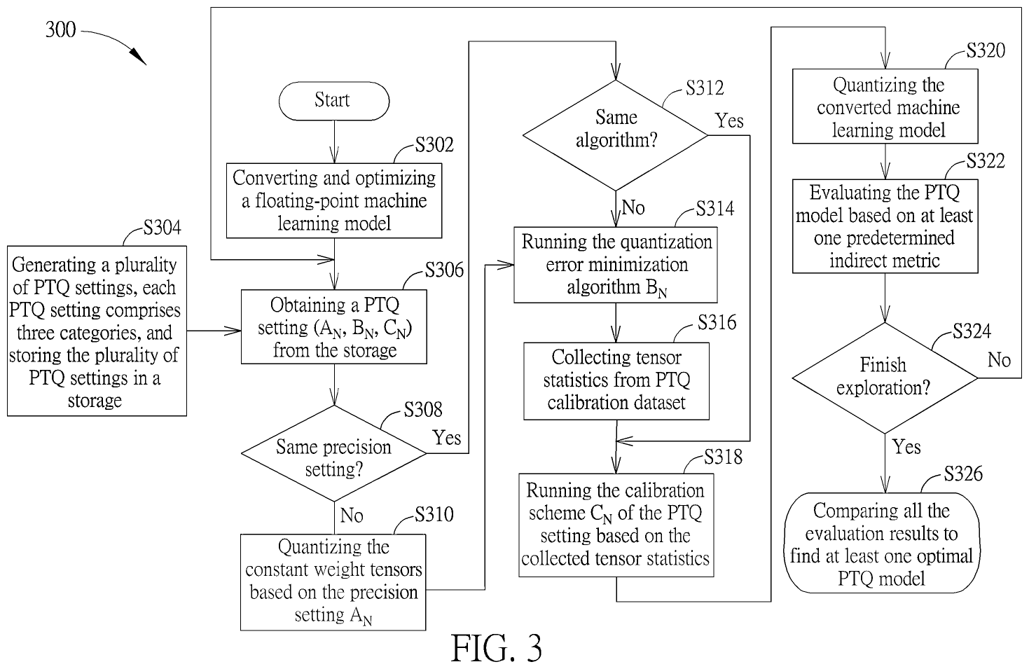

FIG. 3 is a flowchart of a method 300 for finding at least one optimal post-training quantization (PTQ) model according to another embodiment of the present invention. The method 300 may include the following steps:
Step S302: converting and optimizing a floating-point machine learning model into a converted machine learning model;
Step S304: generating a plurality of PTQ settings, each PTQ setting comprises three categories, the three categories comprise precision setting, quantization error minimization algorithm, and calibration scheme, and storing the plurality of PTQ settings in a storage;
Step S306: obtaining a PTQ setting (AN, BN, CN) from the storage;
Step S308: checking whether the precision setting AN of the PTQ setting is the same as the precision setting of the last obtained PTQ setting; if so, go to step S312; else, go to step S310;
Step S310: quantizing the constant weight tensors of the converted machine learning model based on the precision setting AN, and go to S314;
Step S312: checking whether the quantization error minimization algorithm BN of the PTQ setting is the same as the quantization error minimization algorithm of the last obtained PTQ setting; if so, go to step S318; else, go to step S314;
Step S314: running the quantization error minimization algorithm BN to compensate weight quantization error;
Step S316: collecting tensor statistics from PTQ calibration dataset;
Step S318: running the calibration scheme CN of the PTQ setting based on the collected tensor statistics to calibrate the activation tensors of the converted machine learning model;
Step S320: quantizing the converted machine learning model to generate a PTQ model;
Step S322: evaluating the PTQ model based on at least one predetermined indirect metric;
Step S324: checking whether all the PTQ setting are obtained; if so, go to step S326; else, go to step S308; and
Step S326: comparing all the evaluation results to find at least one optimal PTQ model.

In step S302, the flowchart starts by loading the pre-trained floating-point machine learning model, and the floating-point machine learning model is converted and optimized into a converted machine learning model. In an embodiment, the floating-point machine learning model is converted from a neural network training framework (e.g., PyTorch, TensorFlow) to the target framework for model deployment (e.g., TFLite).

In step S304, as an example, configures three PTQ setting categories, that is, configures a plurality of precision settings (A₁, A₂, . . . ), quantization error minimization algorithms (B₁, B₂, . . . ), and calibration schemes (C₁, C₂, . . . ), performs Cartesian product on above three PTQ setting categories to form a plurality of PTQ settings (Aᵢ, Bⱼ, Cₖ), wherein i, j, and k are integers, and {i|i∈Z, 1<=i<=M}, {j|j∈Z, 1<=j<=M}, {k|k∈Z, 1<=k<=M}, and, M>1, sorts the plurality of PTQ settings based on lexicographical order, and stores the sorted PTQ settings in the storage 102. By sorting these PTQ settings based on lexicographical order, to try to put PTQ settings that have the same precision settings (Aᵢ) together, and then try to put PTQ settings with the same quantization error minimization algorithms (Bⱼ) together. Assuming there exist two options for each PTQ setting categories, the PTQ settings order would become: (A₁, B₁, C₁)→(A₁, B₁, C₂)→(A₁, B₂, C₁)→(A₁, B₂, C₂)→(A₁, B₁, C₁)→(A₂, B₁, C₂)→(A₂, B₂, C₁)→(A₂, B₂, C₂). In some embodiments, step S304 may be executed before step S302. In some embodiments, step S304 only need to be executed before step S306.

In step S306, a PTQ setting (AN, BN, CN) is obtained from the storage, wherein N is an integer, and 1≤N≤M. In some embodiments, the PTQ setting (AN, BN, CN) is the first PTQ setting of all the PTQ settings. In some embodiments, another PTQ setting (A_{N-1}, B_{N-1}, C_{N-1}) has been obtained before the PTQ setting (AN, BN, CN).

In step S308, if the precision setting AN is the same as the precision setting A_{N-1} of the last obtained PTQ setting (A_{N-1}, B_{N-1}, C_{N-1}), go to step S312; else, go to step S310. By doing so, the process of the PTQ setting (AN, BN, CN) may skip step S310. In an embodiment, in step S310, if the PTQ setting (AN, BN, CN) is the first PTQ setting (A₁, B₁, C₁), or if the precision setting AN isn't the same as the precision setting A_{N-1} of the last obtained PTQ setting (A_{N-1}, B_{N-1}, C_{N-1}), go to step S310.

In step S312, if the quantization error minimization algorithm BN is the same as the quantization error minimization algorithm B_{N-1} of the last obtained PTQ setting (A_{N-1}, B_{N-1}, C_{N-1}), go to step S318; else, go to step S314. By doing so, the process of the PTQ setting (AN, BN, CN) may skip steps S314 and S316.

In step S316, tensor statistics are collected from PTQ calibration dataset. In an embodiment, the collected tensor statistics are stored in the storage.

In an embodiment, If the answer of step S308 and step S312 are both yes, the steps S310, S314 and S316 can be skipped to reduce the consumption time.

In an embodiment, before executing step S318, the method further comprises checking if the calibration scheme CN of the PTQ setting is the same as the calibration scheme of the last obtained PTQ setting; if so, go to step S320; else, go to step S318.

In step S322, the PTQ model is evaluated based on at least one predetermined indirect metric. In an embodiment, the at least one indirect metric may be signal-to-quantization-noise ratio (SQNR), mean absolute error (MAE), mean squared error (MSE), or cosine similarity. In an embodiment, the evaluation result of each PTQ setting is stored in the storage.

In step S324, if all the PTQ setting are obtained (which means the exploration of PTQ settings is finished), go to step S326; else, go to step S306. It should be noted that, in this disclosure, step S302 only executed once. In an alternative embodiment, step S324 may be executed before step S322.

In step S326, an optimal PTQ model may be a PTQ model has the closest SQNR to the original floating-point machine learning model, or an optimal PTQ model may be a PTQ model which can obtain the smallest MAE compared with the original floating-point machine learning model, or an optimal PTO model may be a PTQ model which can obtain the smallest MSE compared with the original floating-point machine learning model, or an optimal PTQ model may be a PTQ model which can obtain the optimal cosine similarity when compared with the original floating-point machine learning model, or an optimal PTQ model may be a PTQ model has at least one advantage of the above mentioned advantages.

In this embodiment, after executing step S310, go to step S314. However, in another embodiment, after executing step S310, may go to step S312.

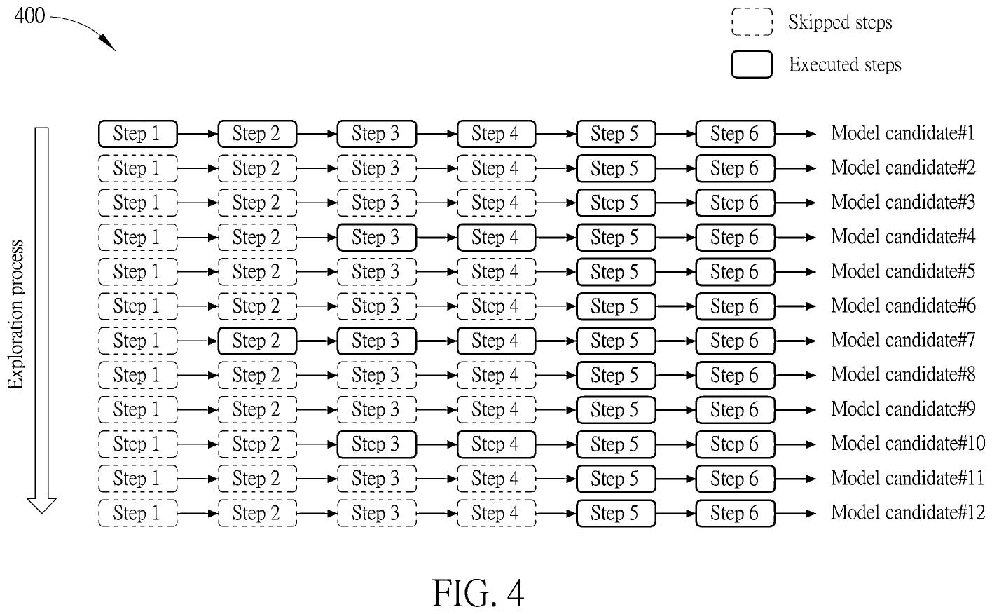

FIG. 4 is a block diagram of an exploration process 400 for finding PTQ model candidates according to an embodiment of the present invention. This embodiment is exemplified by two precision settings, two algorithms, and three calibration schemes. The total number of PTQ options is 12. As an example, a method for generating a PTQ model comprises 6 main steps, they are marked as Steps 1-6. Specifically, in Step 1: convert and optimize a floating-point machine learning model into a converted machine learning model; in Step 2: quantize the constant weight tensors of the converted machine learning model based on a precision setting; in Step 3: run the quantization error minimization algorithm BN to compensate weight quantization error; in Step 4: collect tensor statistics from PTQ calibration dataset; in Step 5: run the calibration scheme CN of the PTQ setting based on the collected tensor statistics; and in Step 6: quantize the converted machine learning model to generate a PTQ model.

As shown in FIG. 4, in the first iteration, the six steps must all be executed since it's the first iteration and the PTQ setting input is the only one PTQ setting being executed. In the second, third, fifth, sixth, eighth, ninth, eleventh, and twelfth iterations, step 1-step 4 can be omitted because the precision settings and quantization error minimization algorithms in these iterations are the same as their respective latest finished iteration. In the fourth and tenth iterations, step 1-step 2 can be omitted because the precision settings in these iterations are the same as their respective latest finished iteration. In the seventh iteration, only step 1 can be omitted because at least the precision settings in these iterations are different from their respective latest finished iteration. The skipped steps are drawn in dashed lines and the executed steps are drawn in solid lines in FIG. 4.

By applying the method of this disclosure, the at least one optimal PTQ model can be found automatically. Besides, by skipping the redundant operations during generating the PTQ models, the consumption time can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for finding at least one optimal post-training quantization (PTQ) model comprising:
converting and optimizing a floating-point machine learning model into a converted machine learning model;
applying a plurality of PTQ settings to generate a plurality of PTQ models; and
evaluating the plurality of PTQ models based on at least one predetermined indirect metric to find at least one optimal PTQ model.

2. The method of claim 1, wherein each of the plurality of PTQ settings comprises a precision setting, a quantization error minimization algorithm, and a calibration scheme, and the method further comprises:
configuring a plurality of precision settings, a plurality of quantization error minimization algorithms, and a plurality of calibration schemes;
performing Cartesian product on the plurality of precision settings, the plurality of quantization error minimization algorithms, and the plurality of calibration schemes to form the plurality of PTQ settings;
sorting the plurality of PTQ settings based on lexicographical order; and
storing the sorted plurality of PTQ settings in the storage.

3. The method of claim 1, wherein each of the plurality of PTQ settings comprises a precision setting, a quantization error minimization algorithm, and a calibration scheme, and when applying the plurality of PTQ settings to generate a plurality of PTQ models, skipping at least one redundant operation if at least two PTQ settings have the same precision setting, quantization error minimization algorithm, or calibration scheme.

4. The method of claim 3, wherein a first PTQ and a second PTQ setting have the same precision setting, skipping at least one redundant operation comprises:
skipping quantizing the constant weight tensors of the converted machine learning model based on the precision setting of the second PTQ setting.

5. The method of claim 3, wherein a first PTQ and a second PTQ setting have the same precision setting and the same quantization error minimization algorithm, skipping at least one redundant operation comprises:
skipping quantizing the constant weight tensors of the converted machine learning model based on the precision setting of the second PTQ setting;
skipping running the quantization error minimization algorithm of the second PTQ setting to compensate weight quantization error; and
skipping collecting tensor statistics from PTQ calibration dataset.

6. The method of claim 3, wherein a first PTQ and a second PTQ setting have the same precision setting, the same quantization error minimization algorithm, and the same calibration scheme, skipping at least one redundant operation comprises:
skipping quantizing the constant weight tensors of the converted machine learning model based on the precision setting of the second PTQ setting;
skipping running the quantization error minimization algorithm of the second PTQ setting to compensate weight quantization error;
skipping collecting tensor statistics from PTQ calibration dataset; and
skipping running the calibration scheme of the second PTQ setting based on the collected tensor statistics to calibrate the activation tensors of the converted machine learning model.

7. The method of claim 1, wherein each of the plurality of post-training quantization settings comprises a precision setting, a quantization error minimization algorithm, and a calibration scheme, and applying the plurality of PTQ settings to generate a plurality of PTQ models further comprises:
(a) obtaining a new PTQ setting from a storage;
(b) checking whether the precision setting of the new PTQ setting is the same as the precision setting of the last obtained PTQ setting, if so, go to (d), else, go to (c);
(c) quantizing the constant weight tensors of the converted machine learning model based on the precision setting of the new PTQ setting, go to (e);
(d) checking whether the quantization error minimization algorithm of the new PTQ setting is the same as the quantization error minimization algorithm of the last obtained PTQ setting, if so, go to (f); else, go to (e);
(e) running the quantization error minimization algorithm of the new PTQ setting to compensate weight quantization error;
(f) collecting tensor statistics from PTQ calibration dataset;
(g) running the calibration scheme of the new PTQ setting based on the collected tensor statistics to calibrate the activation tensors of the converted machine learning model; and
(h) quantizing the converted machine learning model to generate a PTQ model.

8. The method of claim 7, wherein after quantizing the constant weight tensors of the converted machine learning model based on the precision setting of the new PTQ setting, go to (d) instead of going to (e).

9. The method of claim 7, wherein further comprises:
(f-1) checking whether the calibration scheme of the new PTQ setting is the same as the calibration scheme of the last obtained PTQ setting, if so, go to (h); else, go to (g).

10. The method of claim 7, wherein further comprises:
(i) checking whether all the PTQ settings are obtained, if not, go to (a).

11. The method of claim 7, wherein evaluating the plurality of PTQ models based on at least one predetermined indirect metric to find at least one optimal PTQ model comprises:
(i) evaluating the new PTQ model based on at least one predetermined indirect metric;
(j) checking if all the PTQ setting are obtained, if so, go to (k), else, go to (a); and
(k) comparing all the evaluation results to find at least one optimal PTQ model.

12. The method of claim 1, wherein the at least one predetermined indirect metric comprises: signal-to-quantization-noise ratio (SQNR), mean absolute error (MAE), mean squared error (MSE), or cosine similarity.

13. The method of claim 12, wherein evaluating the plurality of PTQ models based on at least one predetermined indirect metric to find at least one optimal PTQ model, further comprises:
executing at least one of the following operations to obtain a plurality of evaluation results:
calculating SQNR difference between the floating-point machine learning model and each of the plurality of PTQ models;
calculating the MAE between the floating-point machine learning model and each of the plurality of PTQ models;
calculating the MSE between the floating-point machine learning model and each of the plurality of PTQ models;
calculating cosine similarity between the floating-point machine learning model and each of the plurality of PTQ models;
and the evaluating step further comprises:
comparing all the evaluation results to find at least one optimal PTQ model.

14. The method of claim 12, wherein the at least one optimal PTQ model is any one or a combination of: a PTQ model has the closest SQNR to the floating-point machine learning model, a PTQ model which can obtain the smallest MAE, a PTQ model which can obtain the smallest MSE, a PTQ model which can obtain the optimal cosine similarity.

15. A non-transitory machine-readable medium for storing a program code, wherein when loaded and executed by a processor, the program code instructs the processor to execute:
converting and optimizing a floating-point machine learning model into a converted machine learning model;
applying a plurality of post-training quantization (PTQ) settings to generate a plurality of PTO models; and
evaluating the plurality of PTQ models based on at least one predetermined indirect metric to find at least one optimal PTQ model.

16. The non-transitory machine-readable medium of claim 15, wherein each of the plurality of post-training quantization settings comprises a precision setting, a quantization error minimization algorithm, and a calibration scheme, and the processor executes:
configuring a plurality of precision settings, a plurality of quantization error minimization algorithms, and a plurality of calibration schemes;
performing Cartesian product on the plurality of precision settings, the plurality of quantization error minimization algorithms, and the plurality of calibration schemes to form the plurality of PTQ settings;
sorting the plurality of PTO settings based on lexicographical order; and
storing the sorted plurality of PTQ settings in the storage.

17. The non-transitory machine-readable medium of claim 15, wherein each of the plurality of post-training quantization settings comprises a precision setting, a quantization error minimization algorithm, and a calibration scheme, and when applying the plurality of PTQ settings to generate a plurality of PTO models, the processor skips at least one redundant operation if at least two PTQ settings have the same precision setting, quantization error minimization algorithm, or calibration scheme.

18. The non-transitory machine-readable medium of claim 15, wherein each of the plurality of post-training quantization settings comprises a precision setting, a quantization error minimization algorithm, and a calibration scheme, and when applying the plurality of PTQ settings to generate a plurality of PTQ models, the processor further executes:
(a) obtaining a new PTQ setting from a storage;
(b) checking whether the precision setting of the new PTQ setting is the same as the precision setting of the last obtained PTQ setting, if so, go to (d), else, go to (c);
(c) quantizing the constant weight tensors of the converted machine learning model based on the precision setting of the new PTQ setting, and go to (e);
(d) checking whether the quantization error minimization algorithm of the new PTQ setting is the same as the quantization error minimization algorithm of the last obtained PTQ setting, if so, go to (f); else, go to (e);
(e) running the quantization error minimization algorithm of the new PTQ setting to compensate weight quantization error;
(f) collecting tensor statistics from PTQ calibration dataset;
(g) running the calibration scheme of the new PTQ setting based on the collected tensor statistics to calibrate the activation tensors of the converted machine learning model; and
(h) quantizing the converted machine learning model to generate a PTQ model.

19. The non-transitory machine-readable medium of claim 18, wherein the processor further executes:
(i) checking whether all the PTQ settings are obtained, if not, go to (a).

20. The non-transitory machine-readable medium of claim 18, when wherein evaluating the plurality of PTO models based on at least one predetermined indirect metric to find at least one optimal PTQ model, the processor further executes:
(i) evaluating the new PTQ model based on at least one predetermined indirect metric;
(j) checking if all the PTQ setting are obtained, if so, go to (k), else, go to (a); and
(k) comparing all the evaluation results to find at least one optimal PTQ model.
